(19) United States
(12) Patent Application Publication
(10) Pub. No.: US 2022/0392078 A1
(43) Pub. Date: Dec. 8, 2022

(54) SEGMENTATION OF X-RAY TOMOGRAPHY IMAGES VIA MULTIPLE RECONSTRUCTIONS

(71) Applicant: National Technology & Engineering Solutions of Sandia, LLC, Albuquerque, NM (US)

(72) Inventors: Dan Stefan Bolintineanu, Albuquerque, NM (US); Enrico C. Quintana, Albuquerque, NM (US); Sharlotte Lorraine Bolyard Kramer, Albuquerque, NM (US); Robert Waymel, Albuquerque, NM (US); Kevin Nicholas Long, Cedar Crest, NM (US)

(21) Appl. No.: 17/338,867

(22) Filed: Jun. 4, 2021

(51) Int. Cl. G06T 7/143; G06T 7/136; G06T 11/00

(52) U.S. Cl. CPC G06T 7/143; G06T 7/136; G06T 11/006; G06T 2207/10081

(57) ABSTRACT

Illustrative embodiments are directed to methods, apparatus and computer program products for segmentation of X-ray tomography images via multiple reconstructions. A computed tomography scan of an object is received. The computed tomography scan is processed to generate an absorption reconstruction and a phase reconstruction from the computed tomography scan. First and second sets of seeds within the phase reconstruction are labeled as corresponding to a first phase by thresholding below a first threshold and corresponding to a second phase by thresholding above a second threshold, respectively. The absorption reconstruction is segmented automatically using an algorithm based on the first set of seeds, the second set of seeds and the absorption reconstruction. A final segmentation is produced based on a combination of the absorption reconstruction and the phase reconstruction.

### GOVERNMENT LICENSE RIGHTS

This invention was made with Government support under Contract No. DE-NA0003525 awarded by the United States Department of Energy/National Nuclear Security Administration. The United States Government has certain rights in this invention.

### BACKGROUND INFORMATION

### 1. Field

The present disclosure relates generally to image processing and to systems and methods for processing X-ray tomography images. More particularly, illustrative embodiments are directed to systems, methods and computer program products for segmentation of X-ray tomography images via multiple reconstructions.

### 2. Background

X-ray computed tomography provides three-dimensional characterization of materials with complex microstructures, such as foams, additively manufactured materials with entrained porosity, and particulate composites. X-ray computed tomography includes acquiring a series of X-ray images of an object as it rotates (typically 360°) between the X-ray source and detector. These images, or projections, are then used to produce a three-dimensional volume of the object being investigated, a process known as image reconstruction. The result is an image or a stack of images, where each image represents a thin cross-sectional slice of the object being imaged. In order to study, understand and quantify the structure of the object being imaged, different phases in the material (e.g. pore and solid) must be identified in these final reconstructed images through a process known as segmentation. This process can be carried out manually by visual inspection, but this introduces significant subjectivity, and can be extremely laborious for large datasets.

Therefore, it would be desirable to have systems, methods and products that take into account at least some of the issues discussed above, as well as other possible issues.

### SUMMARY

The illustrative embodiments provide methods of segmentation of X-ray tomography images via multiple reconstructions comprising receiving a computed tomography scan of an object; processing the computed tomography scan to generate an absorption reconstruction from the computed tomography scan; processing the computed tomography scan to generate a phase reconstruction from the computed tomography scan; labeling a first set of seeds within the phase reconstruction as corresponding to a first phase by thresholding below a first threshold; labeling a second set of seeds within the phase reconstruction as corresponding to a second phase by thresholding above a second threshold; segmenting the absorption reconstruction automatically using an algorithm based on the first set of seeds, the second set of seeds and the absorption reconstruction; and producing a final segmentation based on a combination of the absorption reconstruction and the phase reconstruction.

The illustrative embodiments also provide apparatus for segmentation of X-ray tomography images via multiple reconstructions comprising a receiver configured to receive a computed tomography scan of an object; an absorption reconstruction sub-system configured to generate an absorption reconstruction from the computed tomography scan; a phase recovery reconstruction sub-system configured to generate a phase reconstruction from the computed tomography scan; a seed labeler configured to label a first set of seeds within the phase reconstruction as corresponding to a first phase by thresholding below a first threshold and label a second set of seeds within the phase reconstruction as corresponding to a second phase by thresholding above a second threshold; an automated segmentation sub-system configured to segment the absorption reconstruction automatically using an algorithm based on the first set of seeds and the second set of seeds; and a visualization generator configured to produce a final segmentation based on a combination of the absorption reconstruction and the phase reconstruction.

The illustrative embodiments also provide computer program products for segmentation of X-ray tomography images via multiple reconstructions comprising a non-transitory computer readable storage media; program code, stored on the computer readable storage media, for receiving a computed tomography scan of an object; program code, stored on the computer readable storage media, for processing the computed tomography scan to generate an absorption reconstruction from the computed tomography scan; program code, stored on the computer readable storage media, for processing the computed tomography scan to generate a phase reconstruction from the computed tomography scan; program code, stored on the computer readable storage media, for labeling a first set of seeds within the phase reconstruction as corresponding to a first phase by thresholding below a first threshold; program code, stored on the computer readable storage media, for labeling a second set of seeds within the phase reconstruction as corresponding to a second phase by thresholding above a second threshold; program code, stored on the computer readable storage media, for segmenting the absorption reconstruction automatically using an algorithm based on the first set of seeds and the second set of seeds; and program code, stored on the computer readable storage media, for producing a final segmentation based on a combination of the absorption reconstruction and the phase reconstruction.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a segmentation of X-ray tomography images via multiple reconstructions environment in accordance with an illustrative embodiment;

FIG. 2 is an illustration of a block diagram of a segmentation of X-ray tomography images via multiple reconstructions system in accordance with an illustrative embodiment;

FIG. 3 is illustration of a flowchart of a process for segmentation of X-ray tomography images via multiple reconstructions in accordance with an illustrative embodiment;

FIGS. 4A-4E are illustrations of data corresponding to a sequence of steps for segmentation of X-ray tomography images via multiple reconstructions;

FIGS. 5A-5E are illustrations of data corresponding to a series of steps for segmentation of X-ray tomography images via multiple reconstructions; and

FIG. 6 is an illustration of a block diagram of a data processing system in accordance with an illustrative embodiment.

### DETAILED DESCRIPTION

The illustrative embodiments described herein recognize and take into account different considerations. For example, the illustrative embodiments recognize and take into account that it is desirable to be able to evaluate boundary detection of objects in images in an effective and efficient manner.

Typical reconstruction algorithms utilize absorption (amplitude) information of the detected signal to reconstruct the volume. X-ray phase information is also present but rarely used in most tomographic imaging applications due to a lack of spatial coherence in the X-ray beam. In the context of aforementioned materials science applications, an additional step known as segmentation is often required to interpret and quantify the resulting three-dimensional images. Segmentation entails assigning each voxel (the three-dimensional analogue of a pixel) to a particular material phase, e.g. solid or pore. Segmentation approaches can use a simple threshold of the image grayscale intensity to identify distinct material phases, but more complex approaches have been developed that also take advantage of local image features. These more complex approaches can significantly improve the accuracy of the segmentation. Embodiments of this disclosure can include a segmentation algorithm that takes advantage of multiple images produced via both absorption reconstruction and X-ray phase reconstruction from a single CT (computed tomography) scan. Embodiments of this disclosure leverage both reconstruction methods in combination with a (e.g. random walk-based) segmentation algorithm to generate higher-fidelity segmented images than are achievable using a single reconstruction technique. Without limitation, a suitable random walk algorithm is presented in Grady, Leo “Random walks for image segmentation” IEEE transaction on pattern analysis and machine intelligence, 28.11 (2006) pages 1768-1783. Embodiments of this disclosure can include an automated segmentation algorithm that starts with assigning material phase labels to a subset of voxels for which phase labels are known with high certainty, which we refer to as ‘seed’ labels. Conceptually, segmentation then proceeds by placing random walkers on all of the remaining, unlabeled voxels, and allowing them to carry out a random walk, where the likelihood of a move to a neighboring voxel is inversely proportional to the difference in grayscale intensities of those neighboring voxels. The probability of a given voxel belonging to each material phase is then assigned according to the probabilities of the random walker that started on the given voxel first reaching a seed label voxel corresponding to each phase. The final segmented image is produced by assigning each voxel to the material phase associated with the highest probability.

X-ray phase retrieval reconstruction produces images with improvements in material-phase contrast, such that different phases/components (e.g. pore and solid) in a material show stronger differences in image intensity. However, this comes at the cost of image sharpness near phase/component boundaries. In comparison, the absorption reconstruction provides improved image sharpness near material-phase boundaries, but poorer contrast. Embodiment of this disclosure can include using both reconstructions, in conjunction with the (e.g. random-walker) algorithm described above, to produce high-fidelity segmented images. In particular, embodiments of this disclosure can use the higher-contrast X-ray phase reconstruction to assign label seeds for the random-walker algorithm, then apply the random walk on the standard filtered back projection absorption reconstruction, which has sharper edges. This results in a segmentation that leverages the advantages of both absorption and X-ray phase reconstructions, producing segmented images with sharp resolution near material phase boundaries, and high-fidelity phase assignments.

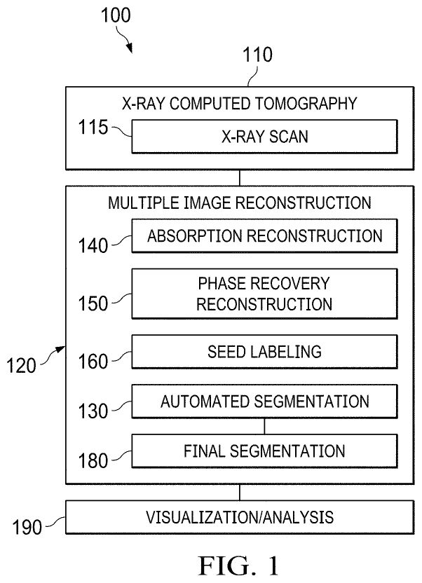

Turning to FIG. 1, an illustration of a block diagram of an X-ray scan processing environment is depicted in accordance with an illustrative embodiment. Segmentation of X-ray tomography images via multiple reconstructions environment 100 includes X-ray computed tomography 110. X-ray computed tomography 110 comprises an X-ray computed tomography scan 115.

Scan 115 from X-ray computed tomography 110 may be processed by multiple image reconstruction 120. For example, without limitation, multiple image reconstruction 120 may be configured to provide automated segmentation 130 followed by final segmentation 180. Automated segmentation can utilize absorption reconstruction 140, phase recovery reconstruction 150 and seed labeling 160.

In accordance with an illustrative embodiment, results from multiple image reconstruction 120 can be presented to visualization/analysis 190. Specifically, material and phase characterization can be performed with higher fidelity and resolution relative to either absorption reconstruction 140 or phase recovery reconstruction 150.

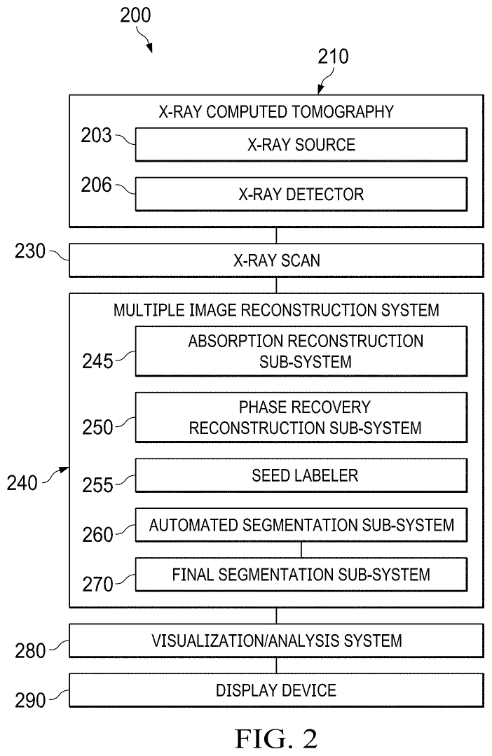

Turning to FIG. 2, an illustration of a block diagram of a segmentation of X-ray tomography images via multiple reconstructions system is depicted in accordance with an illustrative embodiment. Segmentation of X-ray tomography images via multiple reconstructions system 200 is an example of one implementation of segmentation of X-ray tomography images via multiple reconstructions environment 100 in FIG. 1.

Segmentation of X-ray tomography images via multiple reconstructions system 200 includes an X-ray computed tomography 210. X-ray computed tomography 210 includes an X-ray source 203 and an X-ray detector 206. X-ray computed tomography 210 may be an implementation of X-ray computed tomography 110 in FIG. 1.

X-ray computed tomography 210 generates X-ray scan 220. X-ray scan 220 is presented to multiple image reconstruction system 240.

Multiple image reconstruction system 240 includes absorption reconstruction sub-system 245. Multiple image reconstruction system 240 includes phase recovery reconstruction sub-system 250. Multiple image reconstruction system 240 includes seed labeler 255. Multiple image reconstruction system 240 includes automated segmentation sub-system 260. Final segmentation sub-system 270 is coupled to automated segmentation sub-system 260.

Visualization/analysis system 280 is coupled to multiple image reconstruction system 240. Display device 290 is coupled to visualization/analysis system 280.

The illustration of boundary detection evaluation system 200 in FIG. 2 is not meant to imply physical or architectural limitations to the manner in which illustrative embodiments may be implemented. Other components, in addition to or in place of the ones illustrated, may be used. Some components may be optional. Also, the blocks are presented to illustrate some functional components. One or more of these blocks may be combined, divided, or combined and divided into different blocks when implemented in an illustrative embodiment.

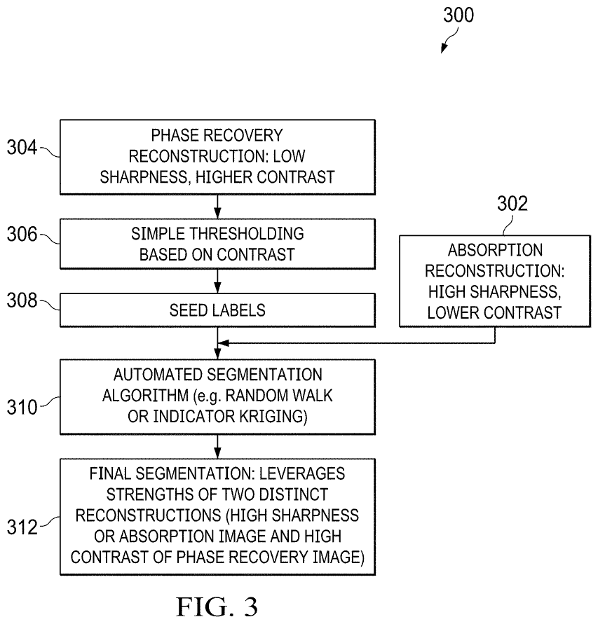

Turning to FIG. 3, an illustration of a flowchart of a process for segmentation of X-ray tomography images via multiple reconstructions is depicted in accordance with an illustrative embodiment. Process 300 is an example, without limitation, of a process for segmentation of X-ray tomography images via multiple reconstructions that may be implemented in segmentation of X-ray tomography images via multiple reconstructions system 200 in FIG. 2.

Process 300 may begin with obtaining an absorption reconstruction (operation 302). Typically, operation 302 provides an absorption reconstruction having relatively high sharpness and relatively low contrast with respect to phase reconstructions. Meanwhile, process 300 may include obtaining a phase recovery reconstruction (operation 304). Typically, operation 304 provides a phase reconstruction having relative low sharpness and relatively high contrast with respect to absorption reconstructions. The obtained phase recovery reconstruction may then undergo simple thresholding based on contrast (operation 306). This thresholding can be used to generate seed labels (operation 308).

An automated segmentation algorithm may then be applied to the absorption reconstruction (operation 310). The automated segmentation algorithm can include random walking or indicator kriging. A final segmentation may then be obtained (operation 312). The final segmentation preferably leverages strengths of the two distinct reconstructions, namely relative high sharpness of an absorption images and relatively high contrast of a phase recovery image.

It may then be determined whether there are other reconstructions to be processed. In response to a determination that there are other reconstructions to be processed, process 300 may return to operations 302 and 304 to obtain another reconstruction to be processed. In response to a determination that there are no other reconstructions to be processed, process 300 may terminate.

Segmenting the absorption reconstruction automatically using the algorithm can be based on both the absorption reconstruction and the phase reconstruction. In this case, the algorithm can include a random walker segmentation algorithm or an indicator kriging segmentation algorithm.

If the algorithm includes a random walker segmentation algorithm, then the random walker segmentation algorithm can hop between adjacent nodes with probability given by:

wᵢⱼ=exp(−β(gᵢ−gⱼ)²)

where:

wᵢⱼ is a probability of a random walker hopping from voxel i to neighboring voxel j;

gᵢ, gⱼ are grayscale intensities at neighboring voxels i and j based on the absorption reconstruction; and

β is an adjustable parameter.

If the algorithm includes an indicator kriging segmentation algorithm, then a probability of assigning non-labeled voxels to each phase can be:

$$P ( {T}_{i} ; {x}_{0} \vert n ) = {\sum }_{α = 1}^{n} {λ}_{a} ( {T}_{i} ; {x}_{0} ) i ( {T}_{i} ; {x}_{α} ) , i = 0 , 1 .$$

where:

P(Tᵢ; x₀|n): probability of assigning phase T to voxel at location x₀, given n seed label voxels in its neighborhood;

λ_{α}(Tᵢ; x₀): weights computed for each point, by solving equations below:

$${\sum }_{β = 1}^{n} {λ}_{β} ( {z}_{c} ; {x}_{0} ) {C}_{I} ( {z}_{c} ; {x}_{α} - {x}_{β} ) + μ ( {z}_{c} ; {x}_{0} ) = {C}_{I} ( {z}_{c} ; {x}_{α} - {x}_{0} ) , \\ α = 1 , … , n , {\sum }_{β = 1}^{n} {λ}_{β} ( {z}_{c} ; {x}_{0} ) = 1 .$$

and

C₁(z_{c}; x_{α}−x_{β}) is a spatial correlation of an indicator variable, computed directly from assigned values.

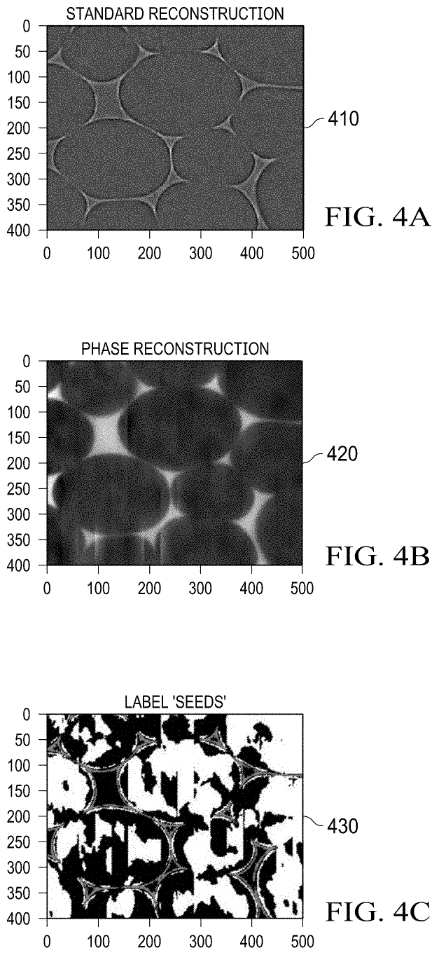

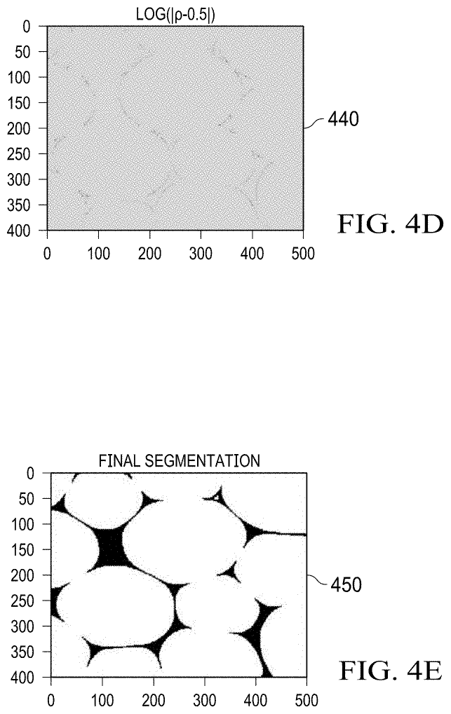

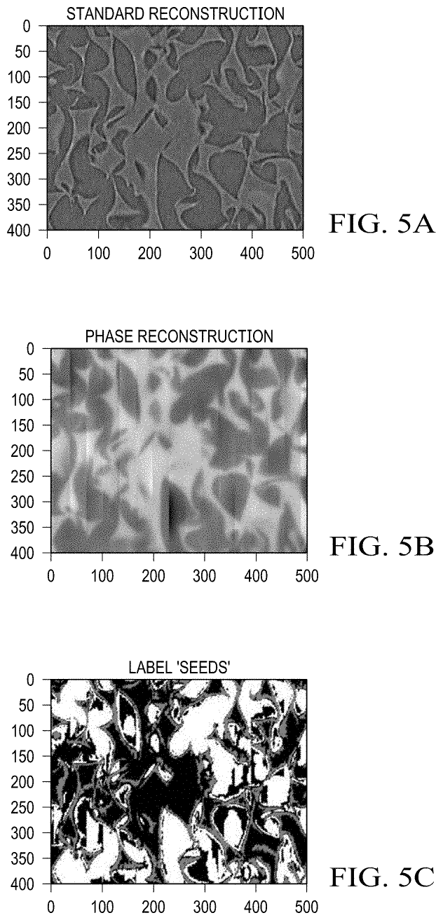

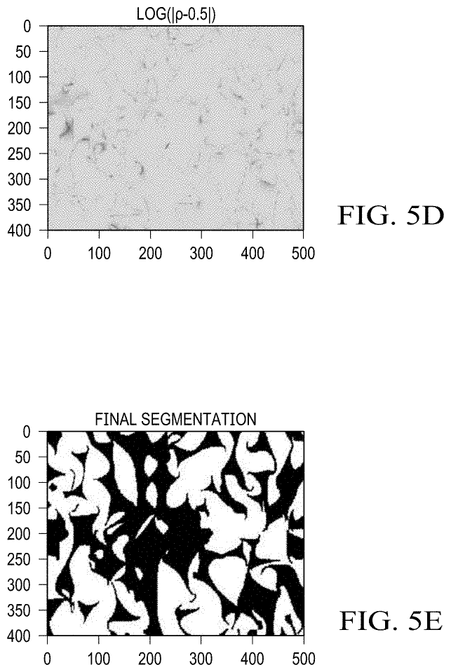

FIGS. 4A-4E and 5A-5E contain image examples from a set of tomographs obtained for polymer-foam samples of various densities imaged at the Argonne National Laboratories Advance Photon Source. In these actual examples, segmented images resulting from the approach described above show significant improvements over traditional threshold-based approaches, or segmentation approaches in commercial software packages that are based on a single reconstruction.

Turning to FIGS. 4A-4E, data is depicted corresponding to a sequence of steps for segmentation of X-ray tomography images via multiple reconstructions are depicted. FIG. 4A shows a standard reconstruction 410. FIG. 4B shows a phase reconstruction 420. FIG. 4C shows labeled first and second sets of seeds 430. FIG. 4D shows segmenting the absorption reconstruction automatically 440 using an algorithm, in this embodiment including log(|p−0.51|), based on the first set of seeds and the second set of seeds. FIG. 4E shows a final segmentation 450.

Turning to FIGS. 5A-5E, data is depicted corresponding to a series of steps for segmentation of X-ray tomography images via multiple reconstructions are depicted. FIG. 5A shows a standard reconstruction 510. FIG. 5B shows a phase reconstruction 520. FIG. 5C shows labeled first and second sets of seeds 530. FIG. 5D shows segmenting the absorption reconstruction automatically 540 using an algorithm, in this embodiment including log(|p−0.51|), based on the first set of seeds and the second set of seeds. FIG. 5E shows a final segmentation 550.

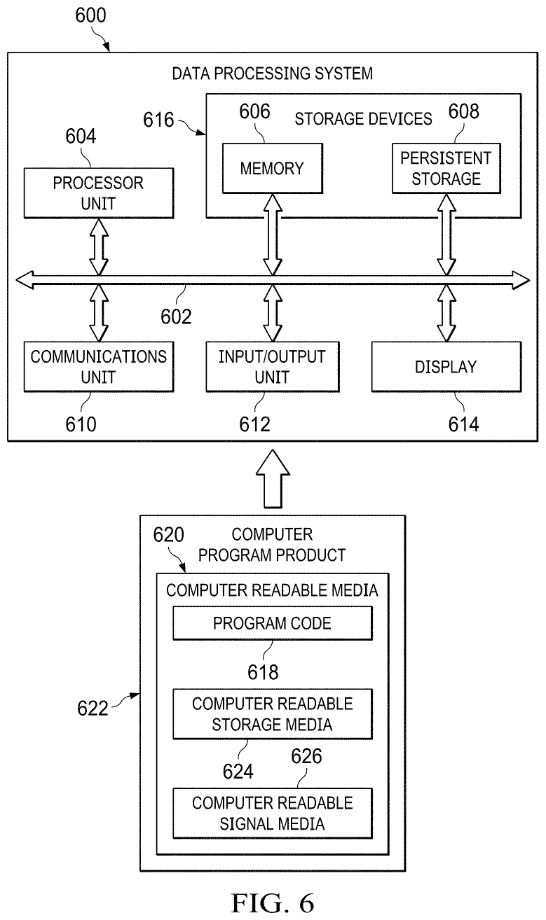

Turning to FIG. 6, an illustration of a block diagram of a data processing system is depicted in accordance with an illustrative embodiment. Data processing system 600 is an example of one possible implementation of a data processing system for performing functions of a boundary detection evaluation system in accordance with an illustrative embodiment. For example, without limitation, data processing system 600 is an example of one possible implementation of a data processing system for implementing the segmentation of X-ray tomography images via multiple reconstructions system 200 in FIG. 2.

In this illustrative example, data processing system 600 includes communications fabric 602. Communications fabric 602 provides communications between processor unit 604, memory 606, persistent storage 608, communications unit 610, input/output (I/O) unit 612, and display 614. Memory 606, persistent storage 608, communications unit 610, input/output (I/O) unit 612, and display 614 are examples of resources accessible by processor unit 604 via communications fabric 602.

Processor unit 604 serves to run instructions for software that may be loaded into memory 606. Processor unit 604 may be a number of processors, a multi-processor core, or some other type of processor, depending on the particular implementation. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device is any piece of hardware that is capable of storing information, such as, for example, without limitation, data, program code in functional form, and other suitable information either on a temporary basis or a permanent basis. Storage devices 616 also may be referred to as computer readable storage devices in these examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these examples, provides for communications with other data processing systems or devices. In these examples, communications unit 610 is a network interface card. Communications unit 610 may provide communications through the use of either or both physical and wireless communications links.

Input/output (I/O) unit 612 allows for input and output of data with other devices that may be connected to data processing system 600. For example, input/output (I/O) unit 612 may provide a connection for user input through a keyboard, a mouse, and/or some other suitable input device. Further, input/output (I/O) unit 612 may send output to a printer. Display 614 provides a mechanism to display information to a user.

Instructions for the operating system, applications, and/or programs may be located in storage devices 616, which are in communication with processor unit 604 through communications fabric 602. In these illustrative examples, the instructions are in a functional form on persistent storage 608. These instructions may be loaded into memory 606 for execution by processor unit 604. The processes of the different embodiments may be performed by processor unit 604 using computer-implemented instructions, which may be located in a memory, such as memory 606.

These instructions are referred to as program instructions, program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these examples. In one example, computer readable media 620 may be computer readable storage media 624 or computer readable signal media 626.

Computer readable storage media 624 may include, for example, an optical or magnetic disk that is inserted or placed into a drive or other device that is part of persistent storage 608 for transfer onto a storage device, such as a hard drive, that is part of persistent storage 1108. Computer readable storage media 624 also may take the form of a persistent storage, such as a hard drive, a thumb drive, or a flash memory, that is connected to data processing system 600. In some instances, computer readable storage media 624 may not be removable from data processing system 600.

In these examples, computer readable storage media 624 is a physical or tangible storage device used to store program code 618 rather than a medium that propagates or transmits program code 618. Computer readable storage media 624 is also referred to as a computer readable tangible storage device or a computer readable physical storage device. In other words, computer readable storage media 624 is a media that can be touched by a person.

Alternatively, program code 618 may be transferred to data processing system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer readable signal media 626 for use within data processing system 600. For instance, program code stored in a computer readable storage medium in a server data processing system may be downloaded over a network from the server to data processing system 600. The data processing system providing program code 618 may be a server computer, a client computer, or some other device capable of storing and transmitting program code 618.

The different components illustrated for data processing system 600 are not meant to provide architectural limitations to the manner in which different embodiments may be implemented. The different illustrative embodiments may be implemented in a data processing system including components in addition to and/or in place of those illustrated for data processing system 600. Other components shown in FIG. 6 can be varied from the illustrative examples shown. The different embodiments may be implemented using any hardware device or system capable of running program code. As one example, data processing system 600 may include organic components integrated with inorganic components and/or may be comprised entirely of organic components excluding a human being. For example, a storage device may be comprised of an organic semiconductor.

In another illustrative example, processor unit 604 may take the form of a hardware unit that has circuits that are manufactured or configured for a particular use. This type of hardware may perform operations without needing program code to be loaded into a memory from a storage device to be configured to perform the operations.

For example, when processor unit 604 takes the form of a hardware unit, processor unit 604 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 618 may be omitted, because the processes for the different embodiments are implemented in a hardware unit.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system.

Additionally, communications unit 610 may include a number of devices that transmit data, receive data, or both transmit and receive data. Communications unit 610 may be, for example, a modem or a network adapter, two network adapters, or some combination thereof. Further, a memory may be, for example, memory 606, or a cache, such as that found in an interface and memory controller hub that may be present in communications fabric 602.

A practical application into which embodiments of this disclosure can be integrated is segmentation of porous material (e.g. polymeric foam) X-ray computed tomography (CT) scans using a combination of absorption reconstruction and phase retrieval reconstruction with an automated segmentation algorithm resulting in higher fidelity segmented images compared to earlier technologies. Embodiments of this disclosure can provide improved image processing. Embodiments of this disclosure can provide significant incremental performance increases.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

$${\sum }_{β = 1}^{n} {λ}_{β} ( {z}_{c} ; {x}_{0} ) {C}_{I} ( {z}_{c} ; {x}_{α} - {x}_{β} ) + μ ( {z}_{c} ; {x}_{0} ) = {C}_{I} ( {z}_{c} ; {x}_{α} - {x}_{0} ) , \\ α = 1 , … , n , {\sum }_{β = 1}^{n} {λ}_{β} ( {z}_{c} ; {x}_{0} ) = 1 .$$

and

C₁(z_{c}; x_{α}−x_{β}) is a spatial correlation of an indicator variable, computed directly from assigned values.

What is claimed is:

1. A method of segmentation of X-ray tomography images via multiple reconstructions, comprising:
receiving a computed tomography scan of an object;
processing the computed tomography scan to generate an absorption reconstruction from the computed tomography scan;
processing the computed tomography scan to generate a phase reconstruction from the computed tomography scan;
labeling a first set of seeds within the phase reconstruction as corresponding to a first phase by thresholding below a first threshold;
labeling a second set of seeds within the phase reconstruction as corresponding to a second phase by thresholding above a second threshold;
segmenting the absorption reconstruction automatically using an algorithm based on the first set of seeds, the second set of seeds and the absorption reconstruction; and
producing a final segmentation based on a combination of the absorption reconstruction and the phase reconstruction.

2. The method of claim 1, wherein segmenting the absorption reconstruction automatically using the algorithm is based on both the absorption reconstruction and the phase reconstruction.

3. The method of claim 2, wherein the algorithm includes a random walker segmentation algorithm.

4. The method of claim 3, wherein the random walker segmentation algorithm hops between adjacent nodes with probability given by:
wᵢⱼ=exp(−β(gᵢ−gⱼ)²)
where:
wᵢⱼ is a probability of a random walker hopping from voxel i to neighboring voxel j
gᵢ, gⱼ are grayscale intensities at neighboring voxels i and j based on the absorption reconstruction and
β is an adjustable parameter.

5. The method of claim 2, wherein the algorithm includes an indicator kriging segmentation algorithm.

6. The method of claim 5, wherein probability of assigning non-labeled voxels to each phase is:
$$P ( {T}_{i} ; {x}_{0} \vert n ) = {\sum }_{α = 1}^{n} {λ}_{a} ( {T}_{i} ; {x}_{0} ) i ( {T}_{i} ; {x}_{α} ) , i = 0 , 1 .$$
where:
P(Tᵢ; x₀|n): probability of assigning phase Tᵢ to voxel at location x₀ given n seed label voxels in its neighborhood
λ_{α}(Tᵢ; x₀): weights computed for each point, by solving equations below:
$${\sum }_{β = 1}^{n} {λ}_{β} ( {z}_{c} ; {x}_{0} ) {C}_{I} ( {z}_{c} ; {x}_{α} - {x}_{β} ) + μ ( {z}_{c} ; {x}_{0} ) = {C}_{I} ( {z}_{c} ; {x}_{α} - {x}_{0} ) , \\ α = 1 , … , n , {\sum }_{β = 1}^{n} {λ}_{β} ( {z}_{c} ; {x}_{0} ) = 1 .$$
and, C₁(z_{c}; x_{α}−x_{β}) is a spatial correlation of an indicator variable, computed directly from assigned values.

7. The method of claim 1, wherein the object includes a porous polymeric foam.

8. An apparatus for segmentation of X-ray tomography images via multiple reconstructions, comprising:
a receiver configured to receive a computed tomography scan of an object;
an absorption reconstruction sub-system configured to generate an absorption reconstruction from the computed tomography scan;
a phase recovery reconstruction sub-system configured to generate a phase reconstruction from the computed tomography scan;
a seed labeler configured to
label a first set of seeds within the phase reconstruction as corresponding to a first phase by thresholding below a first threshold and
label a second set of seeds within the phase reconstruction as corresponding to a second phase by thresholding above a second threshold;
an automated segmentation sub-system configured to segment the absorption reconstruction automatically using an algorithm based on the first set of seeds and the second set of seeds; and
a visualization generator configured to plot a final segmentation based on a combination of the absorption reconstruction and the phase reconstruction.

9. The apparatus of claim 8, wherein the automated segmentation sub-system configured to segment the absorption reconstruction automatically using the algorithm is based on both the absorption reconstruction and the phase reconstruction.

10. The apparatus of claim 9, wherein the algorithm includes a random walker segmentation algorithm.

11. The apparatus of claim 10, wherein the random walker segmentation algorithm hops between adjacent nodes with probability given by:
wᵢⱼ=exp(−β(gᵢ−gⱼ)²)
where:
wᵢⱼ is a probability of a random walker hopping from voxel i to neighboring voxel j
gᵢ, gⱼ are grayscale intensities at neighboring voxels i and j based on the absorption reconstruction and
β is an adjustable parameter.

12. The apparatus of claim 8, wherein the algorithm includes an indicator kriging segmentation algorithm.

13. The apparatus of claim 12, wherein probability of assigning non-labeled voxels to each phase is:
$$P ( {T}_{i} ; {x}_{0} \vert n ) = {\sum }_{α = 1}^{n} {λ}_{α} ( {T}_{i} ; {x}_{0} ) i ( {T}_{i} ; {x}_{α} ) , i = 0 , 1 .$$
where:
P(Tᵢ; x₀|n): probability of assigning phase Tᵢ to voxel at location x₀ given n seed label voxels in its neighborhood
λ_{α}(Tᵢ; x₀): weights computed for each point, by solving equations below:
$${\sum }_{β = 1}^{n} {λ}_{β} ( {z}_{c} ; {x}_{0} ) {C}_{I} ( {z}_{c} ; {x}_{α} - {x}_{β} ) + μ ( {z}_{c} ; {x}_{0} ) = {C}_{I} ( {z}_{c} ; {x}_{α} - {x}_{0} ) , \\ α = 1 , … , n , {\sum }_{β = 1}^{n} {λ}_{β} ( {z}_{c} ; {x}_{0} ) = 1 .$$
and, C₁(z_{c}; x_{α}−x_{β}) is a spatial correlation of an indicator variable, computed directly from assigned values.

14. The apparatus of claim 8, wherein the object includes a porous polymeric foam.

15. A computer program product for segmentation of X-ray tomography images via multiple reconstructions, the computer program product comprising:
a non-transitory computer readable storage media;
program code, stored on the computer readable storage media, for receiving a computed tomography scan of an object;
program code, stored on the computer readable storage media, for processing the computed tomography scan to generate an absorption reconstruction from the computed tomography scan;
program code, stored on the computer readable storage media, for processing the computed tomography scan to generate a phase reconstruction from the computed tomography scan;
program code, stored on the computer readable storage media, for labeling a first set of seeds within the phase reconstruction as corresponding to a first phase by thresholding below a first threshold;
program code, stored on the computer readable storage media, for labeling a second set of seeds within the phase reconstruction as corresponding to a second phase by thresholding above a second threshold;
program code, stored on the computer readable storage media, for segmenting the absorption reconstruction automatically using an algorithm based on the first set of seeds and the second set of seeds; and
program code, stored on the computer readable storage media, for producing a final segmentation based on a combination of the absorption reconstruction and the phase reconstruction.

16. The computer program product of claim 15, wherein segmenting the absorption reconstruction automatically using the algorithm is based on both the absorption reconstruction and the phase reconstruction.

17. The computer program product of claim 16, wherein the algorithm includes a random walker segmentation algorithm.

18. The computer program product of claim 17, wherein the random walker segmentation algorithm hops between adjacent nodes with probability given by:
wᵢⱼ=exp(−β(gᵢ−gⱼ)²)
where:
wᵢⱼ is a probability of a random walker hopping from voxel i to neighboring voxel j
gᵢ, gⱼ are grayscale intensities at neighboring voxels i and j based on the absorption reconstruction and
β is an adjustable parameter.

19. The computer program product of claim 16, wherein the algorithm includes an indicator kriging segmentation algorithm.

20. The computer program product of claim 19, wherein probability of assigning non-labeled voxels to each phase is:
$$P ( {T}_{i} ; {x}_{0} \vert n ) = {\sum }_{α = 1}^{n} {λ}_{a} ( {T}_{i} ; {x}_{0} ) i ( {T}_{i} ; {x}_{α} ) , i = 0 , 1 .$$
where:
P(Tᵢ; x₀|n): probability of assigning phase Tᵢ to voxel at location x₀, given n seed label voxels in its neighborhood
λ_{α}(Tᵢ; x₀): weights computed for each point, by solving equations below:
$${\sum }_{β = 1}^{n} {λ}_{β} ( {z}_{c} ; {x}_{0} ) {C}_{I} ( {z}_{c} ; {x}_{α} - {x}_{β} ) + μ ( {z}_{c} ; {x}_{0} ) = {C}_{I} ( {z}_{c} ; {x}_{α} - {x}_{0} ) , \\ α = 1 , … , n , {\sum }_{β = 1}^{n} {λ}_{β} ( {z}_{c} ; {x}_{0} ) = 1 .$$
and, C₁(z_{c}; x_{α}−x_{β}) is a spatial correlation of an indicator variable, computed directly from assigned values.

21. The computer program product of claim 15, wherein the object includes a porous polymeric foam.
